(19) United States
(12) Patent Application Publication
(10) Pub. No.: US 2004/0109241 A1
(43) Pub. Date: Jun. 10, 2004

(54) Lens for scanners

(76) Inventors: Ming-Te Chou, Taipei (TW); Jung-Chiao Chang, Taipei (TW); Hsin-Tang Chien, Keelung (TW)

Correspondence Address: BIRCH STEWART KOLASCH & BIRCH, PO BOX 747, FALLS CHURCH, VA, 22040-0747, US

(21) Appl. No.: 10/431,516

(22) Filed: May 8, 2003

(30) Foreign Application Priority Data
Dec. 4, 2002 (TW) 091219622

(51) Int. Cl. G02B 3/06; G02B 13/18

(52) U.S. Cl. 359/710

(57) ABSTRACT

The specification discloses a lens for scanners. At the same time of shortening the optical paths among devices in the scanning module of the scanner, the size of the lens increases within a limited range so that the scanner still has a compact dimension. The lens has a cylindrical shape. The rims of the two opposite end surfaces are comprised of two opposite lines and two opposite arcs. The centers of the arcs are located at correspondingly the same positions on the end surfaces. Therefore, the beam can enter one end surface and leave from the other.

### BACKGROUND OF THE INVENTION

1. Field of Invention

The invention relates to a lens for scanners and, in particular, to a lens that increases its size within a limited range as the optical paths among devices of the scanning module in a scanner become shorter.

2. Related Art

In addition to graphics, videos, multimedia, and computerized brief reports, the daily business documents should be completely digitalized too. Although a paperless office has not been realized up to date, the scanning process has played an important role in reducing paper works in businesses.

The scanner is always a popular input device because of its simple operation. One only needs to open the scanner lid, places the original copy on the glass, and closes the lid. Other parts of the scanning job are left to software to control the scanning unit.

The principle of the scanner is to use a mechanical or electronic scanning module to read the image points from a copy of graphics and then to convert it into digital data. Since the image data are obtained by tossing light on the original copy and then scanning the light intensity reflected from the image, it is called the opto-electrical conversion. During the process of reading the image signals of the original copy using the image sensor, the light emitted from the source is projected to the surface of the paper. The light reflected from the image passes through the lens to form an image on the sensor. Through the opto-electrical conversion, the image is converted into an Output voltage. The optical path can be controlled using a cylindrical lens.

As scanners become more compact in size and lighter in weight, the total optical path of the cylindrical lens has to be shortened too. However, as shown in FIG. 1, the size of the cylindrical lens 2 (the radius r1) has to increase. Therefore, the size of the scanner cannot really shrink.

### SUMMARY OF THE INVENTION

In view of the foregoing, it is therefore of great importance to provide a lens that can satisfy the needs for a compact scanner.

A primary objective of the invention is to provide a lens for scanners, so that the size of the lens increases only within an allowed range as the optical paths among all devices in the scanning module get shorter. Therefore, the compactification of scanners can be achieved.

The disclosed lens has a cylindrical shape. The rims of the two end surfaces consist of two opposite lines and two opposite arcs. The centers of the arcs are located at correspondingly the same positions. Therefore, the beam enters one end surface and leaves the other.

When the optical paths of all devices in the scanning module of the scanner get shorter, the size of the lens increases only within a limited range (distance between the two arcs).

The disclosed lens for scanners has the following effects:

(1) As the optical paths of all devices in the scanning module of the scanner shrink, the size of the lens increases only within a limited range.

(2) The material used in the disclosed lens is less than the prior art when the optical paths of all devices in the scanning module of the scanner shrink.

### BRIEF DESCRIPTION OF THE DRAWINGS

The invention will become more fully understood from the detailed description given hereinbelow illustration only, and thus are not limitative of the present invention, and wherein:

FIG. 1 is a schematic view of a conventional lens;

FIG. 2 is a schematic view of the disclosed lens; and

FIG. 3 is a schematic view of a beam passing through the disclosed lens.

### DETAILED DESCRIPTION OF THE INVENTION

The lens 1 according to the invention is used mainly in scanners. The scanner can still be made compact because of the lens size increase when shrinking the optical paths among all devices in the scanning module.

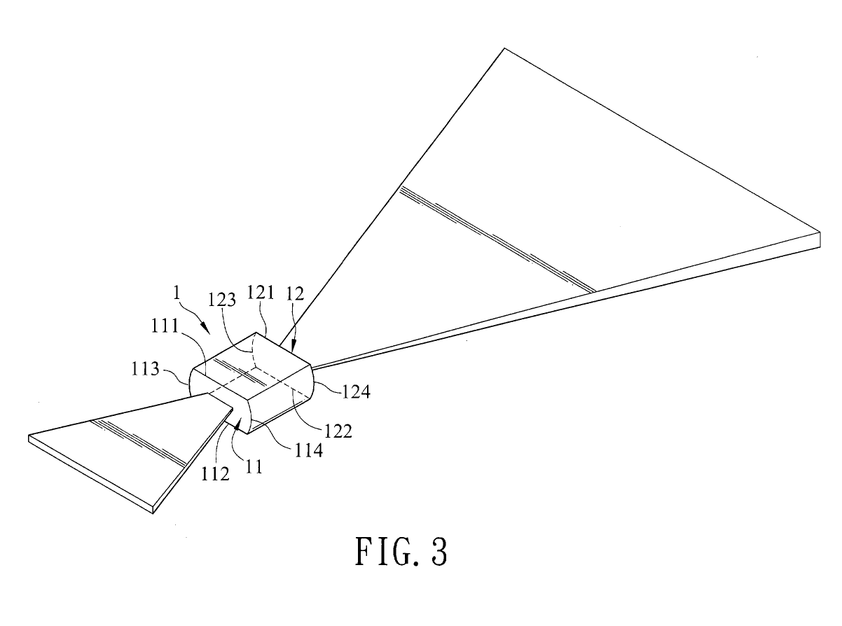

As shown in FIGS. 2 and 3, the disclosed lens 1 has a cylindrical shape. The rims of the opposite end surfaces 11, 12 are comprised of two opposite lens 111, 112, 121, 122 and two pairs of opposite arcs 113, 114, 123, 124. The centers of the arcs 113, 114, 123, 124 are located at correspondingly the same positions on the end surfaces 11, 12. Therefore, the beam enters one end surface 11 (or 12) and leaves the other 12 (or 11).

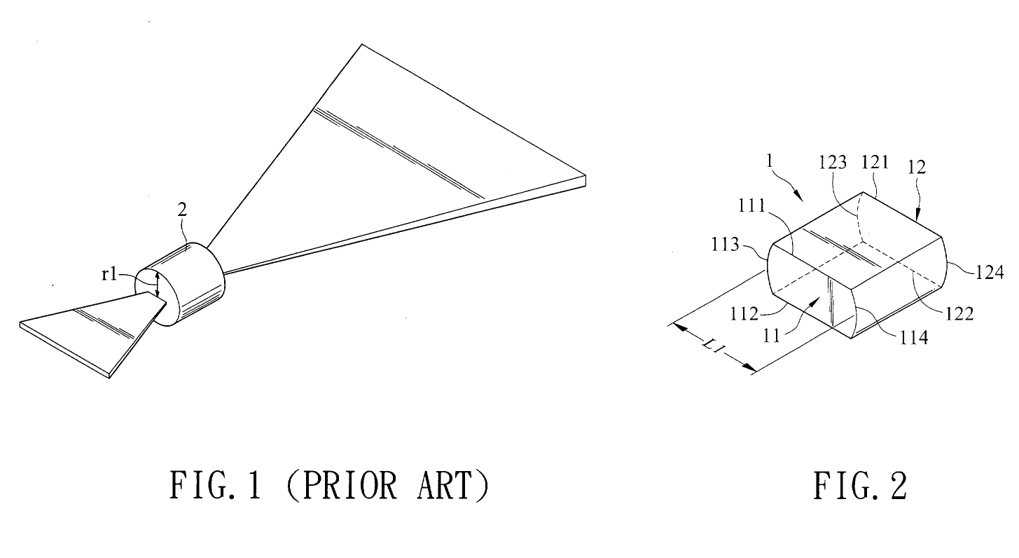

As shown in FIG. 1, at the same time of shrinking the optical paths among all devices in the scanning module of the scanner, the conventional lens 2 has to increase its circular radius r1 in order to shorten the optical paths. However, this prevents the scanner from be compactified. Furthermore, the propagation of the light beam only utilizes the width of the lens 2. Therefore, we do not need to increase the length and width of the lens 2 at the same time. We therefore change the design of the conventional lens 2 into the disclosed lens 1 so that the size increases only within an allowed range. As the optical paths get shorter, the distance L1 between the two arcs 113, 114 of the lens 1 has to be longer. It is also seen that the disclosed lens 1 does not only allow the compactification of the scanner, but also uses less material than the conventional lens 2.

Certain variations would be apparent to those skilled in the art, which variations are considered within the spirit and scope of the claimed invention.

What is claimed is:

1. A lens for scanner characterized in that: the lens has a cylindrical shape, the rims of its two opposite end surfaces are comprised of two opposite lines and two opposite arcs, so that the beam enters one end surface and leaves the other end surface.

2. The lens of claim 1, wherein the centers of the arcs are located on the end surfaces.

3. The lens of claim 1, wherein the centers of the two arcs are located at correspondingly the same positions of the end surfaces.
